(19) United States
(12) Patent Application Publication
(10) Pub. No.: US 2026/0332411 A1
(43) Pub. Date: Oct. 22, 2026

(54) SECURE AGENT-BASED COMMUNICATION ACROSS NETWORK BOUNDARIES USING OUTBOUND CONNECTIONS AND ENCRYPTED MESSAGE RELAYS

(71) Applicant: Wayda Network Corp., San Jose, CA (US)

(72) Inventors: Heping Shang, Walnut Creek, CA (US); Mingchen Lo, Fremont, CA (US); James Shen, San Jose, CA (US)

(21) Appl. No.: 19/184,202

(22) Filed: Apr. 21, 2025

(51) Int. Cl. H04L 9/32

(52) U.S. Cl. CPC H04L 9/32

(57) ABSTRACT

A system enables secure communication between devices across network boundaries using agent-executed software and outbound network connections. A first device may execute a first agent that can generate an encrypted message including a payload and transmit the encrypted message to an intermediary communication hub via an outbound network connection. The intermediary communication hub may be configured to receive and store the encrypted message for retrieval. A second device may execute a second agent that can retrieve the encrypted message from the intermediary communication hub using a second outbound network connection and decrypt the encrypted message to obtain the payload. The system may avoid reliance on inbound firewall connections and can support asynchronous message exchange between devices in distinct network environments.

### BACKGROUND

Computer networks commonly implement firewalls to establish a security boundary between local devices and external networks. Firewalls are configured to block unauthorized access and mitigate cyber threats from external sources such as the internet. Devices within the same local network are typically able to communicate without restrictions, whereas access from external sources generally requires explicit firewall configurations, such as the opening of specific ports or the establishment of Virtual Private Networks (VPNs).

Configuring firewalls to permit external access, such as by opening ports, can expose local networks to security risks, including unauthorized access, denial-of-service attacks, and data breaches. VPNs are frequently used to facilitate secure remote access, but often involve complex setup procedures, introduce network latency, and require ongoing administrative oversight.

Other remote access techniques include the use of cloud-based remote desktop services or port forwarding configurations. These methods may depend on third-party intermediaries or necessitate significant alterations to existing network infrastructure. Such configurations may introduce operational complexity or increase the exposure of internal systems to potential security threats.

### SUMMARY

The present disclosure relates to systems, methods, and apparatuses for enabling secure communication between devices located in distinct network environments. In one example, a system includes a first device that executes a first agent. The first agent may generate an encrypted message containing a payload intended for a second agent, and can transmit the encrypted message to an intermediary communication hub via an outbound network connection originating from the first device. The intermediary communication hub may be configured to receive the encrypted message and store it for later retrieval. A second device may execute the second agent, which can retrieve the encrypted message from the intermediary communication hub using a separate outbound network connection originating from the second device, and decrypt the encrypted message to obtain the payload.

The encrypted message may be associated with a decentralized identifier (DID) corresponding to the second agent. The second agent can verify the DID and determine whether the first agent is authorized to transmit messages to the second device. In some implementations, the second agent may retrieve messages by polling the intermediary communication hub or by subscribing to receive notifications when messages become available. The intermediary communication hub may store encrypted messages without inspecting or decrypting the encrypted messages. Agents may generate and use cryptographic keys to encrypt and decrypt messages exchanged through the hub.

The present disclosure also provides a method that includes executing an agent on a device, generating an encrypted message intended for a counterpart agent, and transmitting the encrypted message to an intermediary communication hub via an outbound network connection. The intermediary communication hub can receive and store the encrypted message for later retrieval by the counterpart agent. The counterpart agent may retrieve the message using a second outbound connection and decrypt the message to access the payload. The method may also include associating the encrypted message with a DID, verifying the DID, determining authorization to transmit messages, and encrypting the payload using cryptographic keys. Retrieval of the message may be performed using polling or subscription mechanisms.

In another example, an apparatus is provided that includes at least one processor and memory storing instructions that, when executed, cause the apparatus to receive an encrypted message from a first agent via a first outbound network connection, associate the message with an identifier corresponding to a second agent, and store the message without decrypting the message. The apparatus may enable retrieval of the message by the second agent using a second outbound network connection in response to a request referencing the identifier. In some implementations, the identifier can be a DID, and the apparatus may enforce access control policies to determine whether retrieval is permitted. Retrieval may be triggered by polling requests or by subscriptions registered by the second agent, which may also result in the apparatus transmitting a notification that the message is available.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 depicts an overview of a system for enabling secure communication between devices located in different networks while preserving the integrity of existing firewall configurations, according to an example implementation.

FIG. 2 depicts a message flow between remote and local devices in which encrypted data is routed through an intermediary communication service, according to an example implementation.

FIG. 3 depicts a method for establishing trusted communication relationships between devices using decentralized identifiers and permission-based access control, according to an example implementation.

FIG. 4 depicts a computer system configured to provide functionality in accordance with various implementations disclosed herein.

FIG. 5 depicts an example implementation of the communication system shown in FIG. 1.

### DETAILED DESCRIPTION

Securing access to local devices from external networks remains a longstanding challenge in the design and administration of computer networks. Firewalls, which act as gatekeepers at network boundaries, are widely used to block unsolicited inbound connections and reduce exposure to external threats. However, this protection comes at the cost of restricting legitimate remote access to devices within the local network.

Enabling such remote access typically involves opening firewall ports or implementing Virtual Private Networks (VPNs). Opening ports can expose systems to unauthorized access, denial-of-service attacks, and other vulnerabilities. VPNs mitigate some of these risks by establishing encrypted tunnels, but VPNs may introduce complexity in configuration, credential management, and ongoing maintenance. VPNs also require centralized administration and infrastructure, and can impose coordination overhead when managing network addressing and permissions across multiple sites.

In contrast, the communication model described in the present disclosure enables decentralized authorization and addressability without requiring inbound connectivity or internet protocol (IP) address coordination. Devices participating in the disclosed system can generate globally unique decentralized identifiers (DIDs) without involving a central authority or conflicting with existing network address assignments. Each participating site or network retains full control over its communication policies: a local agent may determine which external agents are permitted to communicate with its associated devices and to what extent; similarly, each external agent may enforce its own policies regarding communication with the local agent. This self-determined model supports bilateral trust and access granularity, allowing each side to independently specify the terms of engagement. Unlike VPN architectures, which typically rely on shared trust and centralized configuration, the disclosed system allows each site to operate autonomously while maintaining secure and verifiable communication channels.

In some implementations, agents may enforce site-specific access policies based on message metadata, identifier provenance, or pre-established rules. These policies can be defined independently at each participating site, allowing every network to retain control over which external agents are granted access, and to what extent. This model promotes autonomy and trust-by-policy, rather than centralized enforcement.

Cloud-based access methods and port forwarding represent additional attempts to solve this problem. These approaches commonly rely on third-party infrastructure to relay communications between remote and local endpoints. While these approaches simplify certain deployment aspects, they can introduce privacy risks, require changes to firewall or router settings, and may not be suitable for environments with strict compliance or trust requirements.

The present disclosure addresses at least these limitations by providing a communication system that allows devices outside a local network to interact with internal devices without requiring firewall ports to be opened, without relying on VPN tunnels, and without exposing the local network to unsolicited inbound connections. The disclosed system employs agents and intermediary hubs to relay encrypted messages in a manner that is both secure and private. Agents are identified using DIDs and can communicate across networks via hub-based message exchange, where messages are only accessible to authorized recipients. Because the communication model is based on outbound requests initiated by agents, rather than inbound port exposure, firewall traversal is achieved without weakening the defensive posture of the network.

In addition to preserving internal network isolation, the disclosed system may also enhance privacy by preventing third parties from observing which specific endpoints are communicating. Unlike VPNs or traditional client-server models, which expose IP-level traffic patterns that can reveal the source and destination of communication, the intermediary communication hub can decouple message origin from destination. In some implementations, messages may be relayed or stored in a way that prevents the intermediary or external observers from correlating source and destination identifiers. This architecture enables a no-trackability model, in which communication relationships are not externally discoverable, even when hosted on publicly accessible infrastructure. Moreover, users may host their own intermediary hubs to further strengthen privacy assurances and maintain control over observability and logging behavior.

This approach offers distinct advantages in terms of security, ease of deployment, privacy preservation, and support for decentralized architectures, making it particularly suitable for environments where minimal configuration, scalability, and secure inter-network communication are desired.

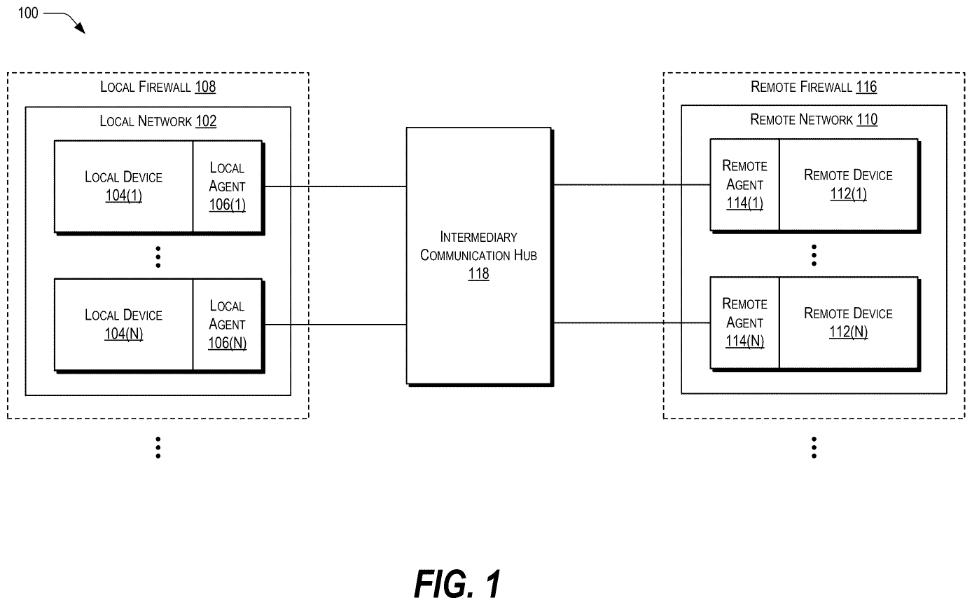

Turning to FIG. 1, shown is an example communication system 100 configured to facilitate secure and privacy-preserving message exchange between devices in different network environments while preserving the default configuration of network firewalls, according to an example implementation. The system 100 enables authorized communication between remote and local devices without requiring inbound firewall ports to be opened, relying instead on agent-based messaging routed through one or more intermediary communication hubs.

The communication system 100 includes a local network 102, which may be a private network, corporate intranet, home network, or any other localized network environment protected by a firewall. The local network 102 includes one or more local devices 104(1)-104(N), which may include desktop computers, laptops, Internet of Things (IoT) devices, servers, printers, or any other network-connected computing device. Each of the local devices 104(1)-104(N) is communicatively associated with a corresponding local agent 106(1)-106(N), which is a software or hardware component configured to interface with external networks through outbound connections.

The local agents 106(1)-106(N) may be implemented as standalone applications, background services, embedded device modules, or virtual network interfaces. A local agent 106 may be responsible for managing outbound communication sessions, encrypting and decrypting messages, performing authentication, enforcing access permissions, and managing identifiers such as decentralized identifiers (DIDs). The local agents 106 may be deployed directly on the local devices 104 or on intermediary devices (e.g., gateways or local servers) within the local network 102.

Access to and from the local network 102 is governed by a local firewall 108, which may be implemented using software firewalls, router-based firewalls, or enterprise-grade firewall appliances. The local firewall 108 enforces inbound and outbound traffic policies. In some configurations, the local firewall 108 permits outbound connections but blocks unsolicited inbound connections. The configuration of the communication system 100 leverages this outbound capability to maintain secure communication without modifying firewall rules or opening inbound ports.

The communication system 100 also includes a remote network 110, which may represent another private network, a cloud-hosted environment, or any external network in which communication with the local network 102 is desired. The remote network 110 includes one or more remote devices 112(1)-112(N), each associated with a corresponding remote agent 114(1)-114(N). The remote devices 112 may include mobile devices, laptops, tablets, workstations, or servers operated by users or automated systems authorized to communicate with the local devices 104 in the local network 102.

The remote agents 114 may have functionally similar to or the same as the local agents 106 and may be responsible for preparing and encrypting outbound messages, initiating communication with intermediary infrastructure, and managing permissions and identifiers. Users can configure agents the way they want. For example, in some implementations, the remote agents 114 may be configured to allow the receipt of responses or notifications from the local devices 104 via the same infrastructure.

The remote network 110 is protected by a remote firewall 116, which may be configured similarly to the local firewall 108. Like the local firewall 108, the remote firewall 116 typically allows outbound connections and blocks unsolicited inbound traffic.

Positioned between the local network 102 and the remote network 110 is an intermediary communication hub 118. The intermediary communication hub 118 is configured to receive encrypted messages from agents in either network and to temporarily store or route those messages for retrieval by the corresponding recipient agent. The intermediary communication hub 118 may be implemented as a cloud-based service, a federated relay node, or an on-premise message broker. The intermediary communication hub 118 is not required to decrypt or interpret message contents, thereby preserving the confidentiality and integrity of communications.

Communication between the local agents 106 and the remote agents 114 is performed in a decoupled and asynchronous manner. For example, a remote agent 114(1) may encrypt a message intended for a local agent 106(1) and transmit the message to the intermediary communication hub 118 using an outbound connection. The local agent 106(1), operating on a polling or subscription basis, subsequently retrieves the encrypted message from the intermediary communication hub 118 via an outbound connection. The message is then decrypted and, if authorized, forwarded to the appropriate local device 104(1).

Because all message transfers originate as outbound requests from agents behind their respective firewalls, the communication system 100 does not rely on direct inbound connectivity, port forwarding, or VPN tunneling. This model reduces administrative complexity and significantly lowers the attack surface of the local network 102.

In some implementations, both the local agents 106 and the remote agents 114 may self-issue or register globally unique decentralized identifiers (DIDs), which are used to authenticate communication partners and enforce access policies. The intermediary communication hub 118 may maintain access control policies specifying which agents are authorized to push or pull messages for particular DIDs. These policies may be managed by the agents themselves or through a distributed registry or directory.

While FIG. 1 illustrates two networks and a single intermediary hub, other implementations may support multiple hubs, multi-hop routing, or peer-to-peer forwarding among authorized agents. Furthermore, the number and type of devices, agents, and networks may vary depending on the deployment scenario.

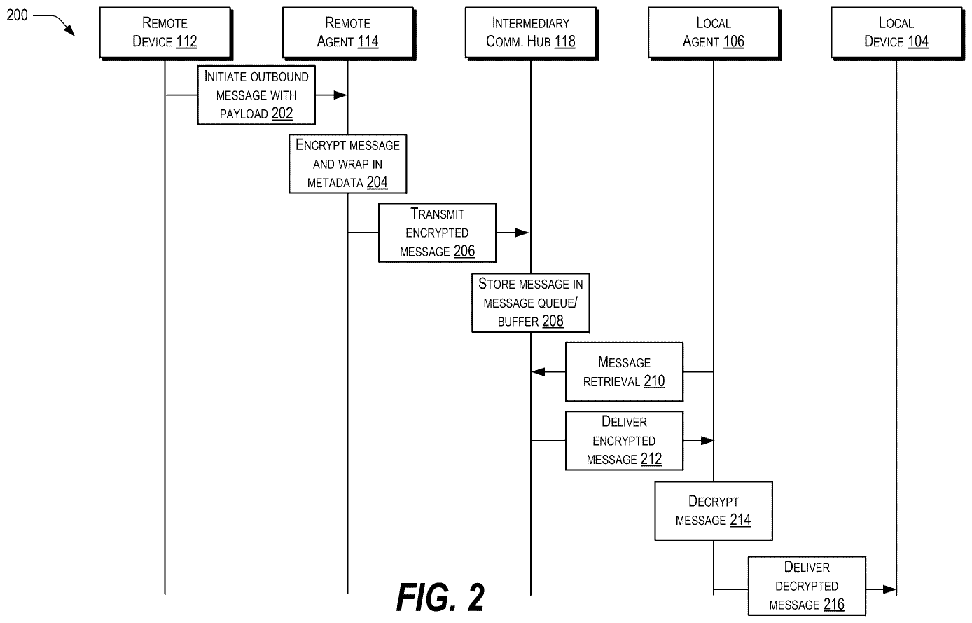

Turning to FIG. 2, shown is an example message exchange sequence 200 within the communication system 100, illustrating how a message originating from a remote device 112 is securely transmitted to a local device 104 through a series of asynchronous operations that preserve existing firewall configurations. The components shown in FIG. 2, including the remote device 112, the remote agent 114, the intermediary communication hub 118, the local agent 106, and the local device 104, were introduced in FIG. 1 and described in further detail above.

In step 202, the remote device 112 initiates an outbound message by generating a payload to be transmitted to the local device 104. The payload may include application data, commands, configuration updates, or other types of communication content.

In step 204, the remote agent 114 encrypts the payload and wraps it in associated metadata. The metadata may include a destination identifier, routing information, and optionally a digital signature or proof of origin. Encryption is performed such that only the intended recipient—namely, the local agent 106—is able to decrypt and process the message.

In step 206, the remote agent 114 transmits the encrypted message to the intermediary communication hub 118 using an outbound network connection. In some cases, the remote agent 114 initiates a push network operation to transmit the encrypted message to the intermediary communication hub 118. The transmission is performed without modifying the firewall 116, relying solely on permitted outbound traffic from the remote network 110.

In step 208, the intermediary communication hub 118 receives the encrypted message and stores it in a message queue or buffer. The intermediary communication hub 118 does not decrypt or interpret the message payload and instead acts as a transient relay point, holding the message until the intended recipient retrieves it. The intermediary communication hub 118 can access the metadata or other non-encrypted portions of the message, which can indicate one or more intended recipients, among other information.

In step 210, the local agent 106 initiates a message retrieval operation by either polling the intermediary communication hub 118 or subscribing to be notified when a message is available. In a polling implementation, the local agent 106 periodically sends outbound requests to query the intermediary communication hub 118 for pending messages. In a subscription-based implementation, the local agent 106 registers an interest in receiving messages addressed to its identifier, and the intermediary communication hub 118 delivers such messages upon availability. Both approaches use outbound connections originating from the local network 102, thereby maintaining the integrity of the local firewall 108. In step 212, the intermediary communication hub 118 delivers the encrypted message to the local agent 106, either in response to a polling request or as part of a subscription-based delivery mechanism.

In step 214, the local agent 106 decrypts the message using its private key or other cryptographic mechanism, verifying the authenticity and integrity of the message payload.

In step 216, the local agent 106 forwards the decrypted message to the local device 104 for processing or response.

The message exchange sequence 200 enables secure, mutually authenticated, and asynchronous communication between the remote device 112 and the local device 104 while preserving existing firewall constraints in both network environments. The use of DIDs and cryptographic proofs enables each agent to verify the identity of its counterpart, ensuring that both the sender and receiver are authenticated before any message exchange occurs. Additionally, the intermediary communication hub 118 may possess its own DID, allowing agents to mutually authenticate the intermediary communication hub 118 when transmitting or retrieving messages. This guarantees that all communication—whether agent-to-agent or agent-to-hub—is cryptographically secured and mutually verifiable. Although the illustrated sequence proceeds in a single direction—from remote to local—similar steps may be performed in the reverse direction to support bidirectional or session-based communication.

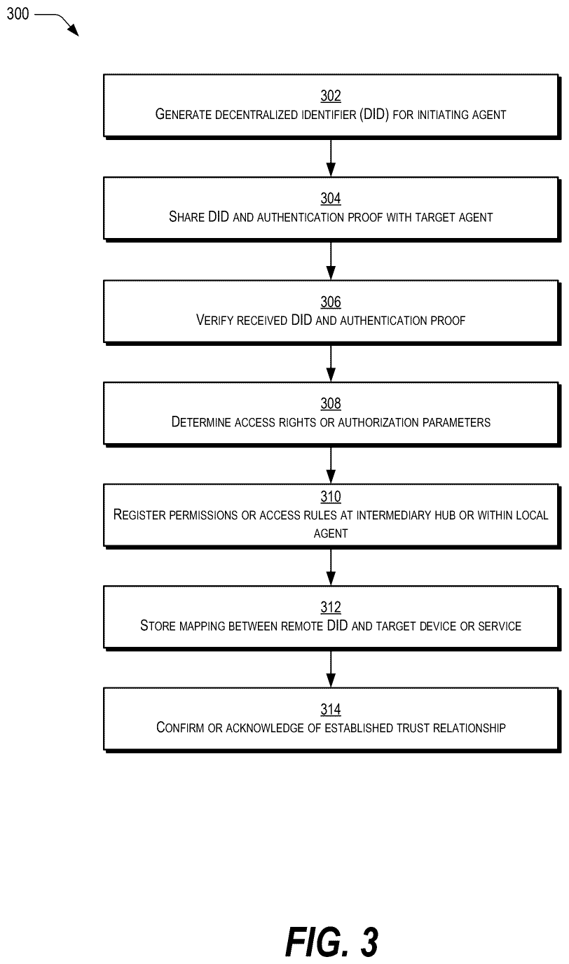

Turning now to FIG. 3, shown is a method 300 for establishing trusted communication relationships between devices using decentralized identifiers and permission-based access control, according to an example implementation. It should be understood that the operations or steps of the methods, sequences, processes, and the like disclosed herein are not necessarily presented in any particular order and that performance of some or all of the operations in an alternative order(s) is possible and is contemplated. The operations have been presented in the demonstrated order for ease of description and illustration. Operations or steps may be added, omitted, and/or performed simultaneously, without departing from the scope of the appended claims.

It also should be understood that the illustrated methods, sequences, or processes disclosed herein can be ended at any time and need not be performed in their respective (or collective) entireties. Some or all operations of the methods, sequences, or processes disclosed herein, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice depending on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For purposes of illustrating and describing the concepts and technologies of the present disclosure, the methods disclosed herein are described as being performed generally by one or more network elements, such as the local network 102, the local device 104, the local agent 106, the local firewall 108, the remote network 110, the remote device 112, the remote agent 114, the remote firewall 116, and/or the intermediary communication hub 118, illustrated and described above as part of the communication system 100. It should be understood that additional and/or alternative systems, devices, and/or network nodes can provide the functionality described herein via execution of one or more modules, applications, and/or other software including, but not limited to, the module disclosed herein. Thus, the illustrated implementations are illustrative, and should not be viewed as limiting in any way.

The method 300 depicts an example implementation of how two agents establish a secure, permission-based relationship that enables subsequent message exchange. The method 300 involves identity generation, authentication, access control evaluation, and permission registration using DIDs and cryptographic mechanisms.

In this context, an initiating agent may be any software or hardware module operating on a remote device 112 (e.g., a user's laptop, mobile device, or a client application) that seeks to initiate communication with another device across a network boundary. A target agent may be a software component operating within a protected local network 102 (e.g., on a local agent 106) that is responsible for managing access to internal resources such as a local device 104 or associated services.

In block 302, the initiating agent generates a DID. A DID is a globally unique identifier that can be cryptographically resolved to public key material and other metadata. This identifier may be self-generated by the agent using a public-private key pair, or obtained through a decentralized identity management system. For example, an agent may generate a DID document conforming to W3C specifications that includes the public key material associated with the agent and service endpoint information.

In block 304, the initiating agent transmits its DID to the target agent, along with an authentication proof. The proof may include a signed message, a nonce-based challenge response, a verifiable credential, or another form of cryptographic attestation demonstrating control over the private key that corresponds to the DID. For instance, the initiating agent might sign a timestamped message with its private key and transmit the signed payload together with its DID.

In block 306, the target agent receives the DID and authentication proof and proceeds to verify them. This may involve resolving the DID to obtain the corresponding public key (e.g., via a decentralized identifier registry or local cache), then validating the cryptographic signature or proof. If the proof includes a verifiable credential, the target agent may also validate its issuer and status using an associated revocation registry. This ensures that the identity of the initiating agent is authentic and that the key material is not expired or revoked. In some implementations, users may authenticate to an agent using an existing identifier or credential (e.g., a platform-specific login). The agent may internally associate this user identity with a system-issued or user-generated DID, which is then used for secure agent-to-agent communication. This layered approach allows existing authentication systems to be leveraged for user access, while maintaining secure, decentralized message exchange at the agent level. Verification of the authentication proof may be performed manually by the operator of the target agent or automatically, based on predetermined criteria defined by the operator.

In block 308, the target agent determines the level of access to be granted to the initiating agent. This may involve evaluating one or more authorization criteria, such as digital signature validity, trust anchors, credential types, or identity attributes contained in the DID metadata. In some implementations, the verification logic may include threshold-based acceptance policies or conditionally applied access levels. For example, the target agent may grant limited or provisional access if certain credentials are present, or defer full access until additional verifications are completed. The target agent may also evaluate one or more locally defined access control rules that reflect policies specific to the second device or its host network. These rules may specify whether the initiating agent is permitted to access particular resources, invoke certain operations, or interact with designated subsystems. These variations allow for flexible access control decisions based on dynamic, context-aware policy evaluation.

In block 310, the target agent registers the resulting access permissions. This may involve updating a local policy store, adding an authorization entry to a session context, or registering an access control rule at the intermediary communication hub 118. For example, the target agent may instruct the hub to allow messages from the DID of the initiating agent to be queued for delivery to a specific local device 104.

In block 312, the target agent stores a mapping between the DID of the initiating agent and the internal resource it is authorized to access. This mapping enables efficient routing of future messages and may be used to enforce authorization at runtime. For instance, the mapping may associate the DID with a particular application programming interface (API) endpoint, service instance, or device interface exposed by the local network 102.

In block 314, the target agent optionally transmits a confirmation or acknowledgment to the initiating agent. This message may include a session token, an access certificate, or a simple acknowledgment of successful registration. In some implementations, the acknowledgment may also include metadata specifying the granted permissions, scope of access, and/or the duration of validity. Once established, the trust relationship between the initiating and target agents may persist across multiple communication sessions, and does not need to be renegotiated for each connection unless the relationship is modified or revoked. This behavior differs from conventional authentication systems, which often require re-authentication each time a new session is initiated. By decoupling trust negotiation from session establishment, the disclosed system reduces repetitive credential exchanges while maintaining security and flexibility.

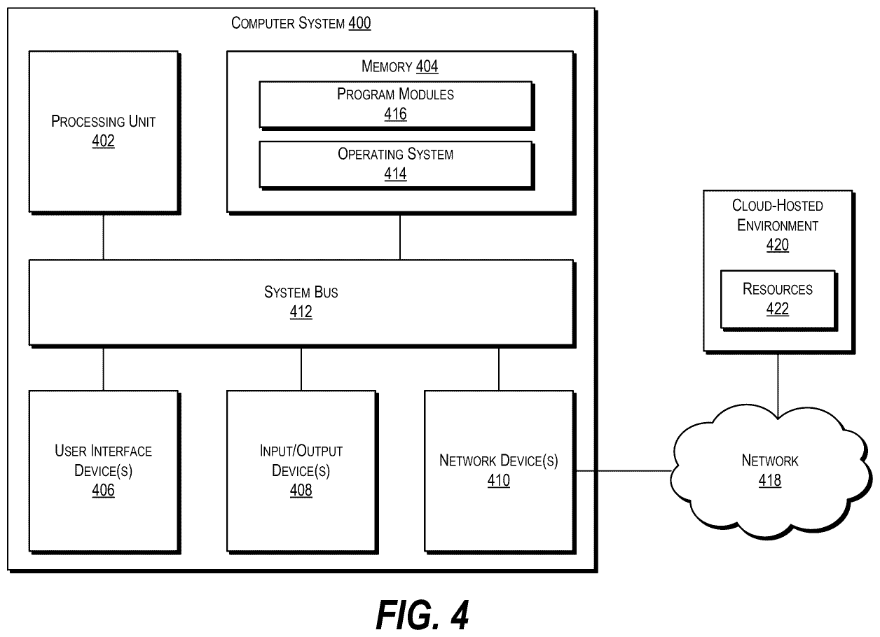

Turning now to FIG. 4, shown is a computer system 400 configured to provide functionality in accordance with various implementations disclosed herein. The systems, devices, and other components disclosed herein can utilize, at least in part, an architecture that is the same as or at least similar to the architecture of the computer system 400. It should be understood, however, that modification to the architecture may be made to facilitate certain interactions among elements described herein.

The computer system 400 includes a processing unit 402, a memory 404, one or more user interface devices 406, one or more input/output (“I/O”) devices 408, and one or more network devices 410, each of which is operatively connected to a system bus 412. The system bus 412 enables bi-directional communication between the processing unit 402, the memory 404, the user interface devices 406, the I/O devices 408, and the network devices 410.

The processing unit 402 may be a standard central processor that performs arithmetic and logical operations, a more specific purpose programmable logic controller (“PLC”), a programmable gate array, or other type of processor known to those skilled in the art and suitable for controlling the operation of the computer system 400. Processing units are known, and therefore are not described in further detail herein.

The memory 404 communicates with the processing unit 402 via the system bus 412. In some implementations, the memory 404 is operatively connected to a memory controller (not shown) that enables communication with the processing unit 402 via the system bus 412. The illustrated memory 404 includes an operating system 414 and one or more program modules 416. The operating system 414 can include, but is not limited to, members of the WINDOWS family of operating systems from MICROSOFT CORPORATION, the LINUX family of operating systems, the MAC OS family of operating systems from APPLE CORPORATION, the FREEBSD family of operating systems, the SOLARIS family of operating systems from ORACLE CORPORATION, other operating systems, and the like.

The program modules 416 may include various software and/or program modules to perform the various operations described herein. The program modules 416 and/or other programs can be embodied in computer-readable media containing instructions that, when executed by the processing unit 402, perform various operations such as those described herein. According to implementations, the program modules 416 may be embodied in hardware, software, firmware, or any combination thereof.

By way of example, and not limitation, computer-readable media may include any available computer storage media or communication media that can be accessed by the computer system 400. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

Computer storage media includes volatile and non-volatile, removable and non-removable media implemented in any method or technology for storage of information such as computer-readable instructions, data structures, program modules, or other data. Computer storage media includes, but is not limited to, random access memory (RAM), read-only memory (ROM), erasable programmable ROM (“EPROM”), electrically erasable programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 400. In the claims, the phrase “computer-readable storage medium” and variations thereof does not include waves or signals per se and/or communication media.

The user interface devices 406 may include one or more devices with which a user accesses the computer system 400. The user interface devices 406 may include, but are not limited to, computers, servers, PDAs, cellular phones, or any suitable computing devices. The I/O devices 408 enable a user to interface with the program modules 416. In one implementation, the I/O devices 408 are operatively connected to an I/O controller (not shown) that enables communication with the processing unit 402 via the system bus 412. The I/O devices 408 may include one or more input devices, such as, but not limited to, a keyboard, a mouse, or an electronic stylus. Further, the I/O devices 408 may include one or more output devices, such as, but not limited to, a display screen or a printer. In some implementations, the I/O devices 408 can be used for manual controls for operations to exercise under certain emergency situations.

The network devices 410 enable the computer system 400 to communicate with other networks or remote systems via a network 418. Examples of the network devices 410 include, but are not limited to, a modem, a radio frequency (“RF”) or infrared (“IR”) transceiver, a telephonic interface, a bridge, a router, a switch, a network card.

The concepts and technologies described herein are supported by various configurations of the computer system 400 and are not limited to the specific examples of the concepts and technologies described herein. This functionality is also implementable all or in part through use of a distributed system, such as over a network 418 via a cloud platform 420 as described below.

The network 418 includes and/or is representative of a cloud platform 420 for resources 422. The cloud platform 420 abstracts underlying functionality of hardware (e.g., servers) and software resources of the network 418. The resources 422 include applications and/or data that can be utilized while computer processing is executed on servers that are remote from the computing system 400. Resources 422 can also include services provided over the Internet and/or through a subscriber network, such as a cellular or Wi-Fi network.

The cloud platform 420 abstracts resources and functions to connect the computer system 400 with other computing devices. The cloud platform 420 also serves to abstract scaling of resources to provide a corresponding level of scale to encountered demand for the resources 422 that are implemented via the cloud platform 420. Accordingly, in an interconnected device implementation, functionality described herein is distributable throughout the computer system 400. For example, the functionality is implementable in part on the computer system 400 as well as via the cloud platform 420 that abstracts the functionality of the network 418.

In implementations, the cloud platform 420 employs a “machine-learning model” that is configured to implement the concepts and technologies described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

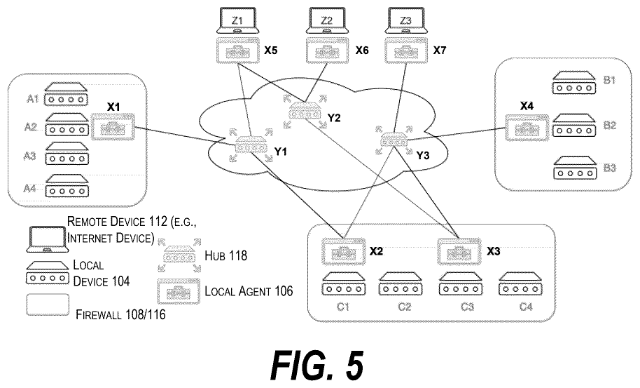

Turning now to FIG. 5, an example implementation of the communication system 100 is now described. Assume person X owns home network A, person Y owns network B, and person Z owns network C. Each network has its own local devices A1-A4, B1-B3, C1-C4, respectively, and one or more local agents 106 responsible for managing access and communication. For instance, network A featuring local devices A1-A4 includes a single local agent 106, network B, featuring local devices B1-B3, includes a single local agent 106, and network C, featuring local devices C1-C4, includes two local agents 106.

When person X travels with a mobile device Z1 outside of their home network (and corresponding firewall), person X may still access their home network A as if physically present. Before departing, person X can configure their local agent 106 in network A to act as a web proxy, allowing mobile device Z1 to access the Internet or other network through the home network and potentially behind the firewall, maintaining familiar access patterns and benefiting from home country-specific services.

Mobile device Z1 may also gain access to person Z's home network C from any location, provided person Z grants the necessary permissions. This showcases the flexibility of the system, allowing secure cross-network access based on mutual agreement and proper authentication.

In the context of home office access, mobile device Z1 may not have default access to person Z's home computers in network C, and devices in network C may not access mobile device Z1, as network A and network C are separate local networks. However, person X and person Z may establish a mutual agreement to link their networks, effectively creating a shared local network environment. In this arrangement, “shared” implies that only person X and person Z, via their respective devices, can access each other's local network resources.

The granularity of access control in this system allows for fine-tuned permissions. Person X may choose to keep certain local devices private by instructing their local agent 106 not to expose those devices. Person Z may implement similar restrictions on their end. This level of control ensures that X and Z maintain complete authority over their local devices and applications, even in a shared network scenario.

The system also supports multi-party arrangements. For instance, person Z and person Y may link their local networks without person X's involvement or knowledge. However, this does not automatically grant person X access to person Y's computers through person Z's local agent 106. If person Z wishes to access person Y's devices, person X and person Y must negotiate and configure their respective local agents 106 accordingly.

This example illustrates how the method described in FIG. 3 can be applied in real-world scenarios, enabling secure, flexible, and controlled access across different network environments. The use of decentralized identifiers (DIDs) and cryptographic proofs allows for robust authentication and authorization, while the granular permission system ensures that each network owner maintains sovereignty over their resources. The system may support various authentication methods and access levels. For instance, person X's mobile device Z1 might use a combination of biometric data and a hardware security key to prove its identity to the home network A. The local agent 106 of the home network may then grant various levels of access based on the strength of the authentication provided and predefined policies.

In scenarios where temporary access is required, the system may support time-bound permissions. For example, if person X needs to grant a contractor temporary access to specific resources in network A, person X can configure their local agent 106 to issue a time-limited credential. This credential can be set to automatically expire after a set period, ensuring that access is revoked without manual intervention.

The flexibility of this system may also extend to integrating with existing identity and access management systems. For instance, in a corporate setting, the local agent 106 can interface with an Active Directory or LDAP system of a corporation, allowing for seamless integration with existing user management and access control policies.

Accordingly, in various embodiments, the system can employ a pull model for communication, where local agents 106 retrieve messages from intermediary communication hubs 118 without requiring open firewall ports. This portless communication approach preserves local network security by eliminating the need for inbound connections. The use of outbound-only connections helps maintain the integrity of existing firewall configurations.

Decentralized Identifiers (DIDs) form the basis of identification for local agents 106 and intermediary communication hubs 118. These globally unique identifiers provide a layer of privacy and security, as they do not reveal information about the owners or their physical locations. The use of DIDs enables secure and pseudonymous communication between entities in the network.

Local agents 106 have the freedom to choose which intermediary communication hubs 118 they use for message exchange and which other local agents 106 with which they communicate. Similarly, intermediary communication hubs 118 can determine which local agents 106 are authorized to use their services. This decentralized decision-making process enhances flexibility and control for all participants.

Local agents 106 will only connect to intermediary communication hubs 118 they can authenticate and authorize, and vice versa. This principle extends to agent-to-agent communication, where message exchange only occurs after successful mutual authentication and authorization. This approach significantly reduces the risk of unauthorized access or impersonation attacks.

The system implements a double encryption scheme to ensure the confidentiality of communications. Messages exchanged between local agents 106 and intermediary communication hubs 118 are encrypted, with only the intended recipients able to decrypt them. Additionally, message payloads between local agents 106 are separately encrypted, ensuring that even the intermediary communication hubs 118 cannot access the content. This layered encryption approach provides strong privacy guarantees and makes it virtually impossible for third parties, including the intermediary communication hubs 118, to track or trace the communication.

It should be understood that many variations are possible based on the disclosure herein. Although features and elements are described above in particular combinations, each feature or element is usable alone without the other features and elements or in various combinations with or without other features and elements.

The implementations disclosed herein can be embodied in hardware, software, or a combination of hardware and software. If implemented in hardware, the implementations can include at least one processing circuit, with at least one storage or memory device. The at least one processing circuit can include, for example, one or more processors and one or more storage or memory devices coupled to a local interface. The local interface can include, for example, a data bus with an accompanying address/control bus or any other suitable bus structure. The storage or memory device can store data or components that are executable by the processors of the processing circuit.

In another example, if embodied in hardware, the implementations can include as a circuit or state machine that employs any suitable hardware technology. The hardware technology can include, for example, one or more microprocessors, discrete logic circuits having logic gates for implementing various logic functions upon an application of one or more data signals, application specific integrated circuits (ASICs) having appropriate logic gates, and/or programmable logic devices (e.g., field-programmable gate array (FPGAs), and complex programmable logic devices (CPLDs)).

If embodied in software, each step or element can represent a module or group of code that includes program instructions to implement the specified logical function(s). The program instructions can be embodied in the form of, for example, source code that includes human-readable statements written in a programming language or machine code that includes machine instructions recognizable by a suitable execution system, such as a processor in a computer system or other system.

Also, one or more of the components described herein that include software or program instructions can be embodied in any non-transitory computer-readable medium for use by or in connection with an instruction execution system such as, a processor in a computer system or other system. The computer-readable medium can contain, store, and/or maintain the software or program instructions for use by or in connection with the instruction execution system.

A computer-readable medium can include a physical media, such as magnetic, optical, semiconductor, and/or other suitable media. Examples of a suitable computer-readable media include, but are not limited to, solid-state drives, magnetic drives, or flash memory. Further, any logic or component described herein can be implemented and structured in a variety of ways. For example, one or more components described can be implemented as modules or components of a single application. Further, one or more components described herein can be executed in one computing device or by using multiple computing devices.

Further, any logic or applications described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices. Additionally, terms such as “application,” “service,” “system,” “engine,” “module,” and so on can be used interchangeably and are not intended to be limiting.

1. A system, comprising:
a first device comprising a first agent executable thereon, the first agent configured to:
generate an encrypted message comprising a payload intended for a second agent, and
transmit the encrypted message to an intermediary communication hub via a first outbound network connection originating from the first device;
the intermediary communication hub configured to:
receive the encrypted message from the first agent, and
store the encrypted message for retrieval by the second agent; and
a second device comprising the second agent executable thereon, the second agent configured to:
retrieve the encrypted message from the intermediary communication hub via a second outbound network connection originating from the second device, and
decrypt the encrypted message to obtain the payload.

2. The system of claim 1, wherein:
the first agent is further configured to associate the encrypted message with a decentralized identifier (DID) corresponding to the second agent; and
the second agent is further configured to verify the DID and determine whether the first agent is authorized to transmit messages to the second device.

3. The system of claim 1, wherein the second agent is further configured to determine, based on locally defined access control rules, whether to permit access to a resource associated with the second device in response to the payload.

4. The system of claim 1, wherein the second agent is further configured to retrieve the encrypted message from the intermediary communication hub by issuing polling requests via the second outbound network connection or by subscribing to receive notifications when messages are available.

5. The system of claim 1, wherein the intermediary communication hub is configured to relay the encrypted message without revealing an identity of the first agent to the second agent or to any external observer.

6. The system of claim 1, wherein the intermediary communication hub is configured to store the encrypted message without decrypting or inspecting the payload.

7. The system of claim 1, wherein the first agent and the second agent are each further configured to generate and use cryptographic keys for encrypting and decrypting the encrypted message.

8. A method, comprising:
executing an agent on a device;
generating, by the agent, an encrypted message comprising a payload intended for a counterpart agent; and
transmitting, by the agent, the encrypted message to an intermediary communication hub via an outbound network connection originating from the device.

9. The method of claim 8, further comprising receiving, by the intermediary communication hub, the encrypted message and storing the encrypted message for retrieval by the counterpart agent.

10. The method of claim 8, further comprising:
retrieving, by the counterpart agent, the encrypted message from the intermediary communication hub via a second outbound network connection originating from a second device; and
decrypting the encrypted message to obtain the payload.

11. The method of claim 8, further comprising associating the encrypted message with a decentralized identifier (DID) corresponding to the counterpart agent.

12. The method of claim 11, further comprising:
verifying, by the counterpart agent, the decentralized identifier; and
determining whether the agent is authorized to transmit messages to a second device associated with the counterpart agent.

13. The method of claim 8, further comprising generating, by the agent, a cryptographic key and using the cryptographic key to encrypt the payload.

14. The method of claim 13, further comprising polling, by the counterpart agent, the intermediary communication hub to retrieve the encrypted message.

15. The method of claim 13, further comprising subscribing, by the counterpart agent, to receive notifications of available messages from the intermediary communication hub.

16. An apparatus, comprising:
at least one processor; and
memory storing computer-readable instructions that, when executed by the at least one processor, cause the apparatus to:
receive an encrypted message transmitted by a first agent via a first outbound network connection originating from a first device;
associate the encrypted message with an identifier corresponding to a second agent;
store the encrypted message without decrypting the encrypted message; and
enable retrieval of the encrypted message by the second agent via a second outbound network connection originating from a second response to a request referencing the identifier.

17. The apparatus of claim 16, wherein the identifier comprises a decentralized identifier (DID) associated with the second agent.

18. The apparatus of claim 16, wherein the memory further stores computer-readable instructions that, when executed by the at least one processor, cause the apparatus to determine, based on an access control policy, whether the second agent is authorized to retrieve the encrypted message.

19. The apparatus of claim 16, wherein the memory further stores computer-readable instructions that, when executed by the at least one processor, cause the apparatus to receive a polling request from the second agent via the second outbound network connection, and to enable retrieval of the encrypted message in response to the polling request.

20. The apparatus of claim 16, wherein the memory further stores computer-readable instructions that, when executed by the at least one processor, cause the apparatus to transmit a notification to the second agent indicating that the encrypted message is available for retrieval in accordance with a subscription previously registered by the second agent.
